(19) United States
(12) Patent Application Publication
(10) Pub. No.: US 2020/0344367 A1
(43) Pub. Date: Oct. 29, 2020

(54) WIRELESS CAMERA AND RELATED SYSTEMS AND METHODS

(71) Applicant: Quartzdyne, Inc., Salt Lake City, UT (US)

(72) Inventors: Brian Jones, Mapleton, UT (US); K. Robert Harker, Herriman, UT (US); Brian T. Leeflang, Salt Lake City, UT (US)

(21) Appl. No.: 16/861,616

(22) Filed: Apr. 29, 2020

Related U.S. Application Data
(60) Provisional application No. 62/840,271, filed on Apr. 29, 2019.

(51) Int. Cl. H04N 1/00; H04N 1/44

(52) U.S. Cl. CPC H04N 1/00307; H04N 2201/0084; H04N 1/4413; H04N 1/00095

(57) ABSTRACT

A wireless camera configured to transmit image data wirelessly to a mobile device, wherein the mobile device is configured to display and/or store the image data, and the wireless camera does not include internal storage for storing any image data. Wireless camera networks are also disclosed.

### CROSS-REFERENCE TO RELATED APPLICATION

This application claims the benefit under 35 U.S.C. § 119(e) of U.S. Provisional Patent Application Ser. No. 62/840,271, filed Apr. 29, 2019, the disclosure of which is hereby incorporated herein in its entirety by this reference.

### TECHNICAL FIELD

Embodiments of the present disclosure generally relate to cameras. In particular, embodiments of the present disclosure relate to wireless cameras and related systems and networking methods.

### BACKGROUND

Cameras may be used for capturing, recording and/or transmitting video or images to computing devices for viewing, editing, processing, and/or storage. For example, security cameras may capture images in an area of interest, such as in and around a commercial building, around a residence, in and around public buildings, around parks, etc. In another example, trail cameras may capture and store images internally for a period of time before the trail cameras are retrieved and the image data is collected. Cameras may be coupled to external devices through, for example, wiring (e.g., coaxial cable, CAT5 cable, CAT6 cable, etc.), direct connection (e.g., USB, SD card, etc.), or wireless connections (e.g., radio, etc.).

### BRIEF SUMMARY

Some embodiments may include a wireless camera network. The wireless camera network may include one or more cameras. Each camera of the one or more cameras may include an image capture device and a transmitter. In some embodiments, the one or more cameras may not include internal storage configured to store image data captured by the image capture device. The transmitter may be configured to transmit the image data. The wireless camera network may further include a mobile device, which may include a receiver and a storage device. The receiver may be configured to receive the image data from the one or more cameras and store the image data in the storage device. The mobile device may also include a display for displaying one or more videos and/or images associated with the image data.

### BRIEF DESCRIPTION OF THE DRAWINGS

While the specification concludes with claims particularly pointing out and distinctly claiming embodiments of the present disclosure, the advantages of embodiments of the disclosure may be more readily ascertained from the following description of embodiments of the disclosure when read in conjunction with the accompanying drawings in which:

FIG. 1 illustrates a simplified diagrammatic view of an example wireless camera system according to an embodiment of the present disclosure;

FIG. 2 illustrates simplified diagrammatic view of another example wireless camera system according to an embodiment of the present disclosure;

FIG. 3 illustrates simplified diagrammatic view of yet another wireless camera system according to an embodiment of the present disclosure;

FIG. 4 illustrates simplified diagrammatic view of an example wireless camera network according to an embodiment of the present disclosure;

FIG. 5 illustrates simplified diagrammatic view of another example wireless camera network according to an embodiment of the present disclosure;

FIG. 6 illustrates simplified diagrammatic view of yet another wireless camera network according to an embodiment of the present disclosure;

FIG. 7 illustrates a flow diagram of example application processes according to an embodiment of the present disclosure; and

FIG. 8 is a block diagram illustrating a mobile device and a camera.

### DETAILED DESCRIPTION

The illustrations presented herein are not meant to be actual views of any particular camera system or component thereof, but are merely idealized representations employed to describe illustrative embodiments. The drawings are not necessarily to scale.

As used herein, the term “substantially” in reference to a given parameter means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, at least about 99% met, or even at least about 100% met.

As used herein, relational terms, such as “first,” “second,” “top,” “bottom,” etc., are generally used for clarity and convenience in understanding the disclosure and accompanying drawings and do not connote or depend on any specific preference, orientation, or order, except where the context clearly indicates otherwise.

As used herein, the term “and/or” means and includes any and all combinations of one or more of the associated listed items.

Cameras may be used to record or transmit events (e.g., sports games, concerts, performances, etc.), monitor surroundings, record instructional videos, record videos for entertainment, etc. Often having multiple views from, for example, different angles or distances may be desirable or even necessary to avoid blind spots and/or to enable a viewer to access different perspectives of the recording or transmission. Multi-camera systems generally require complex storage and transmission equipment, such as a computer system with individual connections to each camera. These complex systems may be time consuming and/or expensive to operate. For example, the programming and hardware requirements of the computer system may require a significant investment of time and money, and the computer system often requires involving costly experts at least for installation and initial setup.

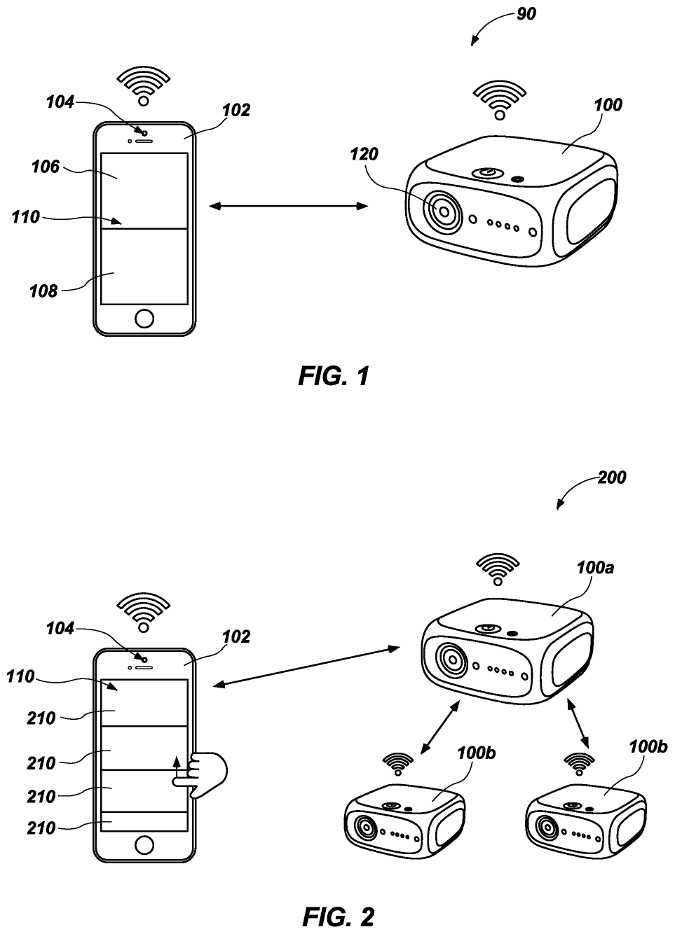

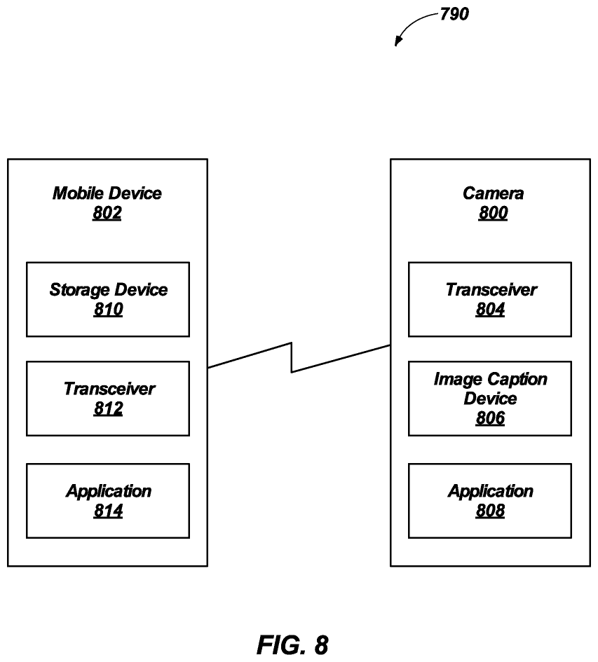

FIG. 1 illustrates an example wireless camera system 90 including a camera (e.g., a mobile camera) 100 configured to be wirelessly coupled to a mobile device 102 (e.g., cell phone, smart phone, tablet, notebook computer, laptop, etc.), according to one or more embodiments of the disclosure. The mobile device 102 may include at least one integrated camera 104 and a display 110. Further, the mobile device 102 may include one or more transceivers (not shown in FIG. 1; see e.g., FIG. 8) and one or more applications (e.g., app, program, etc.) (not shown in FIG. 1; see e.g., FIG. 8). The mobile camera 100 may include an image capturing device 120 and one or more transceivers (not shown in FIG. 1; see e.g., FIG. 8). Further, in some embodiments, the mobile camera 100 may include one or more applications (not shown in FIG. 1; see e.g., FIG. 8).

For example, the mobile camera 100 may be configured to couple to the mobile device 102 through radio communication (e.g., Bluetooth, 3G, 4G, 5G, external wireless router, etc.). According to various embodiments, the mobile camera 100 may be configured to capture image data (e.g., raw image data), and transmit the image data image data wirelessly to the mobile device 102. The image data may be captured via the image capturing device 120 that may include components such as a camera lens, image capture circuitry, photovoltaic sensors, etc. The image data may take the form of arrays of data representing light and/or color for small areas of the image (e.g., pixels). In some embodiments, the image data may include video data that may also have a frame number associated with each array of data, such that each array of image data may be consecutively arranged to display a video. For example, the image data may be a data stream of consecutive arrays of image data. In some embodiments, the image data may include time data (e.g., time stamp), date data (e.g., date stamp), and/or location data (e.g., GPS data, wireless location data, etc.). By way of non-limiting examples, the image data may be greater than 1 megabyte (MB), such as between about 1 MB and about 999 MB, between about 1 MB and about 500 MB, or between about 1 MB and about 100 MB for each image or frame from each mobile camera. In other examples, the image data may be approximately 1 MB or less.

According to various embodiments, an application (e.g., app, program, etc.) (not shown in FIG. 1; see FIG. 8) loaded on the mobile device 102 may enable a user to view, transmit, and/or record image data (e.g., images, pictures, stop motion, video stream, etc.) captured by one or more of the mobile camera 100 and the integrated camera 104. For example, the application may display a first view 106 and a second view 108 on the display 110 of the mobile device 102. The first view 106 may correspond to the integrated camera 104 (i.e., to display data from the integrated camera 104), and the second view may correspond to the mobile camera 100 (i.e., to display data from the mobile camera 100). In some embodiments, the application may enable the user to assign the first view 106 and the second view 108 to the respective cameras 100, 104.

In some embodiments, the application may enable the user to select image data to display, record, and/or transmit. For example, the user may select image data from the integrated camera 104 to view (e.g., via the display 110) and/record (e.g., at a first instance), and the user may select image data from the mobile camera 100 to view and/or record (e.g., at a second instance). In another example, the user may select image data from the mobile camera 100 to transmit to another device (e.g., at a first instance), and the user may select image data from the integrated camera 104 to transmit to another device (e.g., at a second instance). In some embodiments, the application may enable a user to fill the display 110 with a single view 106, 108 or enlarge one view 106, 108 with respect to other views 106, 108. In some embodiments, the application may enable the user to display, save, record, edit, or transmit the image data from all views at the same instant. In some embodiments, the application may automatically record a portion of the image data from each camera 100, 104 enabling the user to manipulate the image data. For example, the application may enable the user to rewind the image data, playback the image data, move through the image data frame by frame, capture the image data from a single frame, etc.

FIG. 2 illustrates another example wireless camera system 200 including a network of mobile cameras 100 and a number of mobile devices 102, in accordance with various embodiments of the disclosure. In some embodiments, a primary camera 100a may operate as an access point (e.g., broker, server, router, filter, etc.) for the mobile device 102 to access image data from one or more secondary cameras 100b. According to some embodiments, the secondary cameras 100b may transmit image data to the primary camera 100a wirelessly. In some embodiments, the wireless transmission between the secondary cameras 100b and the primary camera 100a may have at least some signal properties (e.g., frequency, protocol, etc.) that are different from the signal properties of the wireless transmission between the primary camera 100a and the mobile device 102. In some embodiments, the wireless transmission between the secondary cameras 100b and the primary camera 100a may have at least one signal property that is the same as a signal property of the wireless transmission between the primary camera 100a and the mobile device 102. For example, the primary camera 100a may require credentials (e.g., user and password, device registration, subscription, etc.) before routing image data to the mobile device 102 and/or allowing the mobile device 102 to access image data from the secondary cameras 100b.

The primary camera 100a may be configured to relay the image data from the secondary cameras 100b to the mobile device 102. In some embodiments, the primary camera 100a may operate as the access point for the image data from the secondary cameras 100b without storing, editing, or otherwise adjusting the image data. In other words, the primary camera 100a may manage network traffic between the secondary cameras 100b and the mobile device 102 without managing the image data. Accordingly, in some embodiments, the cameras 100, whether primary camera 100a or secondary cameras 100b, may be manufactured with little to no internal storage, which may reduce one or more of the complexity, expense, likelihood of damage, etc. for the mobile cameras 100. In other embodiments, one or more of the cameras 100 may include any amount of internal storage.

According to some embodiments, the mobile device 102 may include an application (not shown in FIG. 2; see FIG. 8) for controlling at least some functionality of one or more of the cameras and/or managing the image data from one or more of the cameras 100. The application may enable a user to view the image data from multiple cameras simultaneously. For example, the application may display multiple views 210 on the display 110 of the mobile device 102, wherein each view 210 may correspond to a different camera 100. For larger networks, the application may provide an interface that enables the user to view a subset of views 210. For example, the views 210 may be displayed as tiles in multiple windows such as 2 tiled views 210 per window, 4 tiled views 210 per window, etc. The user may select the window with the views 210 that the user wishes to see. In some embodiments, the user may customize which views 210 are displayed in each window thereby grouping views 210 that may be more useful to the user when viewed together. In some embodiments, the views 210 may be displayed in a continuous list of views 210 as illustrated in FIG. 2 such that the user may scroll through the list of views 210 to find the desired view 210. In some embodiments, the application may enable the user to customize the list, such as placing the views 210 in different orders within the list. For example, the user may place views 210 that are likely to be used often or viewed the most at the top of the list while placing less used views 210 near the bottom of the list.

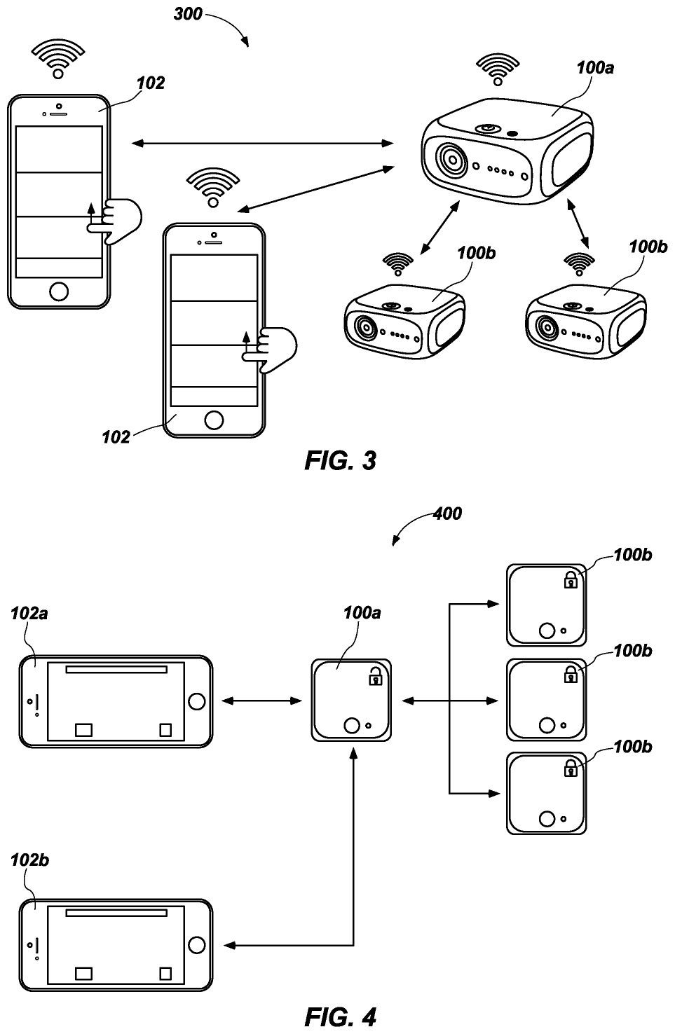

FIG. 3 illustrates yet another example wireless camera system 300 including a network of multiple cameras 100 and a number of mobile devices 102, according to various embodiments of the disclosure. In these embodiments, the primary camera 100a may operate as an access point for image data transmitted from one or more secondary cameras 100b. Further, in some embodiments, the primary camera 100a may transmit image data from one or more of cameras 100 to more than one mobile device 102 simultaneously via wireless communication.

In some embodiments, different mobile devices 102 may be allowed to access to image data from different cameras 100. For example, the primary camera 100a may provide access to the image data from one or more of the cameras 100 in the network to the mobile devices 102 that have provided the proper credentials. For example, one mobile device 102 may provide a first set of credentials. In this example, the primary camera 100a may allow the mobile device 102 with the first set of credentials to access the image data from all of the cameras 100 in the network. Further, a second mobile device 102 may provide a second set of credentials. In this, example, the primary camera 100a may allow the mobile device 102 with the second set of credentials to only access the image data from the primary camera 100a and/or a subset of the secondary cameras 100b.

FIG. 4 illustrates a network diagram of an example wireless camera network 400 including multiple cameras 100 and a number of mobile devices 102, in accordance with various embodiments of the disclosure. In these embodiments, the primary camera 100a may operate as an access point for image data from one or more of the secondary cameras 100b. For example, the cameras 100 may communicate using a publish-subscribe protocol (e.g., MQ Telemetry Transport (MQTT), Advance Message Queueing Protocol (AMQP), Java Message Service (JMS), Extensible Messaging and Presence Protocol (XMPP), etc.). For example, each individual camera 100 may publish the respective image data to the primary camera 100a. A user that operates the network (i.e., operated under the primary camera 100a) may adjust what image data is available based on different credentials. For example, the primary camera 100a may compare credentials provided by each mobile device 102 and determine which image data is available for each mobile device 102. Once the primary camera 100a has determined the image data that is available to the mobile device 102, the primary camera 100a may allow the mobile device 102 to access to the available image data for the mobile device 102.

For example, a first mobile device 102a may provide a first set of credentials to the primary camera 100a. Image data from the primary camera 100a and each of the secondary cameras 100b may be available based on the first set of credentials. Therefore, the primary camera 100a may allow the first mobile device 102a to access the image data from each of the primary and secondary cameras 100a, 100b. Further, for example, a second mobile device 102b may provide a second set of credentials to the primary camera 100a. The user may provide that the second set of credentials only provides access to the image data from the primary camera 100a. Therefore, in this example, the primary camera 100a may allow the second mobile device 102b to have access to the image data from the primary camera 100a while simultaneously blocking access to the image data from all of the secondary cameras 100b.

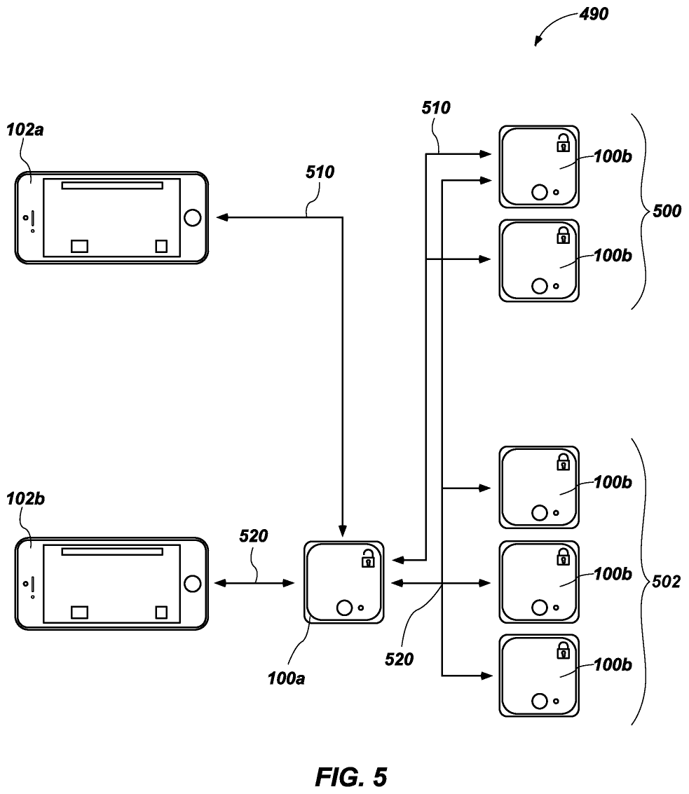

FIG. 5 illustrates a network diagram of a wireless camera network 490 including multiple cameras 100 and a number of mobile devices 102, according to various embodiments of the disclosure. In these embodiments, the primary camera 100a may operate as an access point for image data from the secondary cameras 100b. For example, the secondary cameras 100b may define credentials that provide access to the image data from each respective secondary camera 100b. In some embodiments, the secondary cameras 100b may have distinct users. For example, the cameras 100 in a first set of cameras 500 may be operated by a first user and cameras 100 in a second set of cameras 502 may be operated by a second user. The users may separately assign access privileges to the cameras 100 in the respective sets of cameras 500, 502. For example, the access privileges may be transmitted from each of the secondary cameras 100b to the primary camera 100a as network operation instructions.

In some embodiments, a single primary camera 100a may operate as an access point for both the cameras 100 in the first set of cameras 500 and the cameras 100 in the second set of cameras 502. For example, the second user may have (e.g., control and/or operate) a primary camera 100a operating as an access point to the secondary cameras 100b in the second set of cameras 502. Further, the first user may only have (e.g., control and/or operate) secondary cameras 100b in the associated first set of cameras 500. For the first user to access the image data from the secondary cameras 100b in the first set of cameras 500 with a first mobile device 102a, the first set of cameras 500 may transmit the image data and network operation instructions to the primary camera 100a in the second set of cameras 502. Likewise, the first mobile device 102a may provide credentials to the primary camera 100a in the second set of cameras 502. The primary camera 100a may then grant the first mobile device 102a access to the image data from any of the cameras in the first set of cameras 500 and/or second set of cameras 502 to which the credentials are matched based on the network operation instructions, as illustrated by arrows 510. For example, if the first mobile device 102a is associated with the first user, the primary camera 100a may grant access to all of the cameras 100 in the first set of cameras 500. If the second user has granted the first user access to the image data from any of the cameras 100 in the second set of cameras 502, such as the primary camera 100a, the primary camera 100a may also grant access to the image data from the associated cameras 100.

The second user may have (e.g., control and/or operate) a second mobile device 102b. The second mobile device 102b may provide credentials to the primary camera 100a associated with the cameras 100 accessible by the second user. For example, the second user may have access to all of the cameras in the second set of cameras 502. In some embodiments, the first user may grant the second user access to the image data from one or more of the cameras 100 in the first set of cameras 500. The primary camera 100a may evaluate the credentials from the second mobile device 102b and grant access to the image data from the cameras 100 that are accessible by the credentials provided by the second mobile device 102b as illustrated by arrows 520.

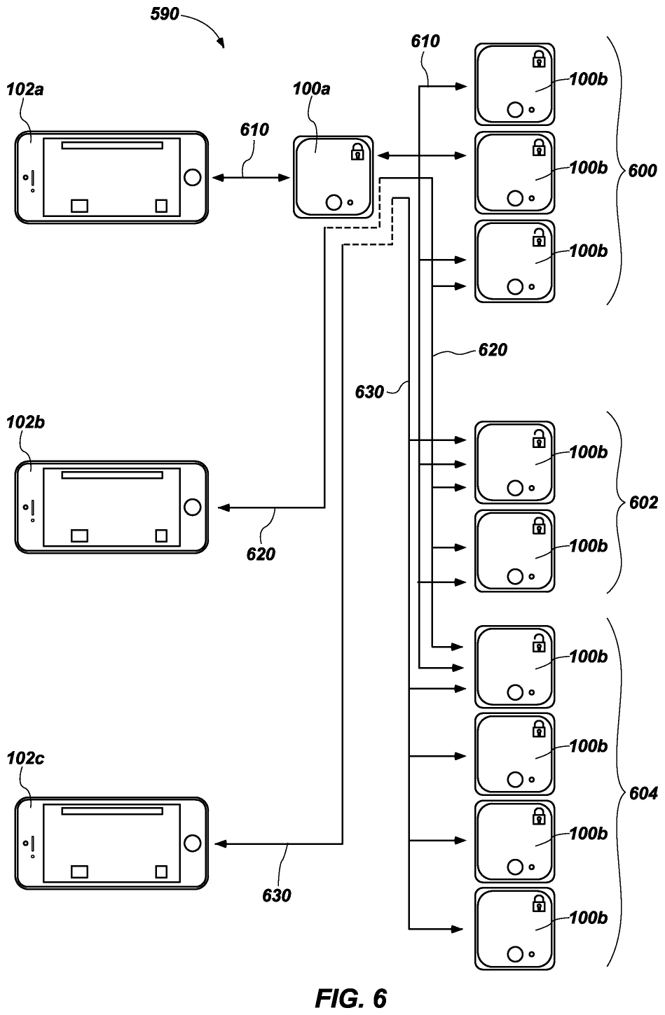

FIG. 6 illustrates a network diagram of another example wireless camera network 590 including multiple cameras 100 and a number of mobile devices, in accordance with various embodiments of the disclosure. In these embodiments, the primary camera 100a may operate as an access point for the image data from the secondary cameras 100b. In some embodiments, the secondary cameras 100b may define credentials that provide access to the image data from each respective secondary camera 100b, and provide operating instructions to the primary camera 100a. In some embodiments, a single primary camera 100a may act as an access point to multiple groups of cameras 100. For example, the primary camera 100a from a first group of cameras 600 associated with a first user may act as an access point for cameras 100 in a second group of cameras 602 associated with a second user, and a third group of cameras 604 associated with a third user. In some embodiments, the first user may be granted access to the cameras 100 of the first group of cameras 600 and one or more cameras 100 from the second group of cameras 602 and/or the third group of cameras 604 with the first user's credentials as illustrated by arrows 610.

In some embodiments, the primary camera 100a may operate as an access point to image data from the secondary cameras 100b while simultaneously blocking access to the image data from the primary camera 100a by one or more users. For example, the primary camera 100a may grant access to the image data from the cameras 100 in the second group of cameras 602 to a second mobile device 102b having credentials associated with the second user. However, if the first user has not granted access to the image data from the primary camera 100a for the credentials associated with the second user, the primary camera 100a may grant access to the cameras 100 associated with the second user's credentials while not allowing access to the image data from the primary camera 100a associated in the first group of cameras 600 as illustrated by arrows 620.

In some embodiments, the first user may block access to image data from some of the cameras 100 in the first group of cameras 600 for a third user and allow access to the image data from the same cameras 100 for a second user. For example, the first user may grant access to the image data from one or more of the secondary cameras 100b in the first group of cameras 600 to a second mobile device 102b having credentials associated with the second user as illustrated by arrows 620. The first user may also deny access to the image data from all of the secondary cameras 100b in the first group of cameras 600 by a third mobile device 102c having credentials associated with the third user as illustrated by arrows 630.

In some embodiments, the second and third groups of camera 602, 604 may selectively grant and/or block access to one or more of the cameras 100 in each respective group. For example the second user may grant access to the image data from one of the secondary cameras 100b in the second group of cameras 602 to one or both mobile devices 102a, and 102c with credentials associated with the first user and the third user respectively.

In some embodiments, access to the cameras 100 in the second group of cameras 602 and the third group of cameras 604 may be controlled at the primary camera 100a. Accordingly, the cameras 100 in the second group of cameras 602 and the third group of cameras 604 may publish (e.g., transmit) the associated image data from each camera 100 to the primary camera 100a.

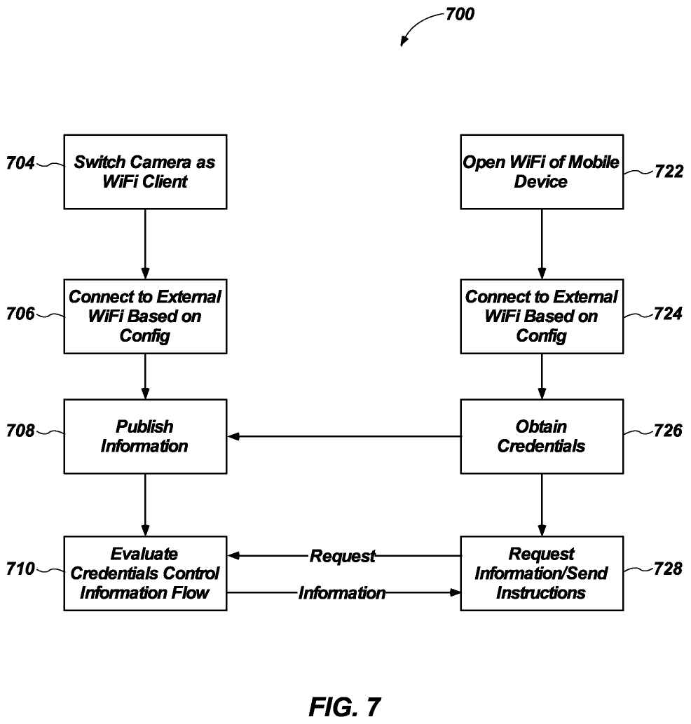

FIG. 7 is an example flow diagram 700 illustrating operational processes of one or more applications of the mobile cameras 100 and one or more applications of the mobile device 102, according to various embodiments of the disclosure. A mobile camera application (e.g., an application executing on the mobile camera 100) may set up the mobile camera 100 as a wireless client, as illustrated in act 704. Setting up the wireless client may enable a wireless connection between multiple mobile cameras 100 forming a multi-camera network. Setting up the wireless client may involve defining a primary camera 100a and secondary cameras 100b. The secondary cameras 100b may be assigned to at least one primary camera 100a. In some embodiments, a camera 100 set up to operate as a secondary camera 100b on one network may be set up to operate as a primary camera 100a on another network. In some embodiments, a user may set up permissions within the primary camera 100a. The permissions may be instructions for which image data is available to each set of credentials and/or which image data may be available without credentials.

The mobile camera 100 may be connected wirelessly to an external network for communicating with the mobile device 102, as illustrated in act 706. For example, the mobile camera application may connect the mobile camera 100 to the external network. For example the external wireless communication may be through another wireless router or server, through local wireless such as Bluetooth, or through a wireless internet protocol such as 3G, 4G, 5G, etc.

The mobile camera 100 may publish the image data on the camera network, as illustrated in act 708. For example, the mobile camera application may publish the image data on the camera network. For example, the secondary cameras 100b may publish the associated image data to the primary camera 100a. The primary camera 100a may also publish the associated image data to an internal gateway (e.g., software gateway, filter, etc.).

The mobile camera 100 may receive information from the mobile device and transmit data based on the information as illustrated in step 710. For example, the mobile device 102 may send a data request in step 728. For example, a mobile device application (e.g., an application of the mobile device 102) may send and/or cause the request to be sent. The mobile camera 100 may check credentials provided by the mobile device 102, or the mobile camera 100 may request credentials from the mobile device 102 and then check the credentials. The mobile camera 100 may publish image data to the mobile device 102 according to the permissions granted to the credentials. The primary camera 100a may release the permissible image data to the mobile device 102. For example, the primary camera 100a may release the permissible image data at the internal gateway such that the image data passes through the mobile camera 100 internal gateway to the mobile device 102.

The mobile device application may initialize a wireless connection as illustrated in act 722. For example, the mobile device 102 may initialize a local connection such as Bluetooth etc. In some embodiments, the mobile device 102 may connect to an existing wireless network, such as through a router, server, or other wireless protocol (e.g., 3G, 4G, 5G, etc.). The mobile device 102 may connect to the at least one of the cameras 100 (e.g., the primary camera 100a) through the wireless connection, as illustrated in act 724. For example, the mobile device application may connect the mobile device 102 to at least one of the cameras 100.

The mobile device 102 may be credentialed for access to the image data through the camera network as illustrated in act 726. For example, the mobile device 102 may be credentialed via the mobile device application. For example, the mobile device 102 may be assigned credentials (e.g., license, registration, etc.) when the application is installed on the mobile device 102. In some embodiments, the application may require login information (e.g., username and password) to determine the proper credentials for the mobile device. In some embodiments, the primary camera 100a may require that the mobile device 102 be registered with the primary camera 100a to determine and/or assign the proper credentials.

The mobile device 102 may request image data from the primary camera 100a and/or send instructions, such as zoom in or zoom out, focus adjustments, movement (e.g., pan up, pan down, pan left, pan right, etc.) and other camera control or adjustment instructions. The primary camera 100a may compare the credentials associated with the mobile device 102 and allow or block information transfer (e.g., transmission of image data, transmission of instructions, etc.) based on the credentials of the mobile device 102.

Modifications, additions, or omissions may be made to the flow diagram without departing from the scope of the present disclosure. For example, the acts of flow diagram 700 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

FIG. 8 is a block diagram 790 including a camera 800 and a mobile device 802. The camera 800, which may include one or more cameras disclosed herein (e.g., the mobile camera 100), may include one or more transceivers (e.g., including a transmitter and a receiver) 804 and one or more image capture devices 806. In some embodiments, the camera 800 may also include one or more applications 808. Further, mobile device 802, which may include one or more mobile devices disclosed herein (e.g., the mobile device 102), may include one or more storage devices 810, one or more transceivers (e.g., including a transmitter and a receiver) 812, and one or more applications 814. As disclosed herein, the camera 800 and the mobile device 802 may be configured to communicate via wireless communication.

Using mobile devices to set up a multi-camera network may enable users to record or transmit multiple views of an event at a relatively low cost. Mobile cameras may be manufactured for a relatively low cost when compared to alternative cameras that may be used. Mobile cameras may also be more robust (e.g., less fragile or less likely to sustain damage from falls, drops, etc.). Accordingly, multi-camera networks using mobile cameras may reduce the production cost for recording events such as sporting event or children's performances or producing low cost instructional or entertainment videos such as those distributed on social media (e.g., FACEBOOK®, LINKEDIN®, YOUTUBE®, etc.) and other internet sites.

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this disclosure. Indeed, various modifications of the present disclosure, in addition to those shown and described herein, such as alternative useful combinations of the elements described, may become apparent to those skilled in the art from the description. Such modifications and embodiments are also intended to fall within the scope of the appended claims and their legal equivalents.

What is claimed is:

1. A wireless camera network comprising:
one or more cameras comprising an image capture device and a transmitter, wherein the one or more cameras do not include internal storage, and wherein the transmitter is configured to transmit image data captured via the image capture device; and
a mobile device comprising a receiver and a storage device, wherein the receiver is configured to receive the image data from the transmitter and store the image data in the storage device.

2. The wireless camera network of claim 1, wherein the one or more cameras comprise at least two cameras.

3. The wireless camera network of claim 2, wherein the at least two cameras comprise a primary camera and a secondary camera, wherein the primary camera is configured to act as an access point for receiving the image data from the secondary camera and transmitting both image data from the secondary camera and image data from the primary camera to the mobile device.

4. The wireless camera network of claim 1, wherein the image data is transmitted using a publish-subscribe messaging protocol.

5. The wireless camera network of claim 4, wherein the image data comprises data between about 1 Megabyte (MB) and about 100 MB.

6. The wireless camera network of claim 4, wherein a primary camera selected from the one or more cameras is configured to control the publish-subscribe messaging protocol as a broker.

7. The wireless camera network of claim 1, wherein the mobile device comprises at least two mobile devices.

8. The wireless camera network of claim 7, wherein each of the at least two mobile devices have assigned credentials.

9. The wireless camera network of claim 8, wherein the one or more cameras are configured to control access to image data based on the assigned credentials.

10. A wireless camera network comprising:
a primary camera comprising a first image capture device and a first transceiver, wherein the primary camera does not include internal storage configured to store image data captured by the first image capture device, and wherein the first transceiver is configured to transmit the image data captured by the first image capture device;
a secondary camera comprising a second image capture device and a second transceiver, wherein the secondary camera does not include internal storage configured to store image data captured by the second image capture device, and wherein the second transceiver is configured to transmit the image data captured by the second image capture device to the primary camera; and
a mobile device comprising a receiver and a storage device, wherein the receiver is configured to receive, from the transceiver of the primary camera, the image data captured by the first image device and the image data captured by the second image capture device, wherein the mobile device is configured to store the image data captured by the first image device and the image data captured by the second image capture device in the storage device.

11. The wireless camera network of claim 10, wherein the mobile device is configured to manage the image data received from the primary camera through an application.

12. The wireless camera network of claim 10, wherein the primary camera is configured to control access to the image data from the primary camera and the image data from the secondary camera.

13. The wireless camera network of claim 12, wherein the primary camera is configured to control access to the image data from the primary camera independently from the image data from the secondary camera.

14. The wireless camera network of claim 10, wherein the primary camera further comprises a storage device configured to store access information.

15. A wireless camera comprising:
an image capture device;
a transmitter;
a receiver;
wherein the wireless camera does not include internal storage configured to store image data captured by the image capture device; and
a non-transitory computer readable medium storing instructions thereon that, when executed by at least one processor, cause the at least one processor to:
receive the image data captured by the image capture device;
receive at least one secondary image data stream from at least one secondary wireless camera through the receiver;
receive credentials from a mobile device through the receiver;
check the credentials against stored access control information; and
transmit, via the transmitter, at least one of the image data captured by the image capture device and the at least the secondary image data stream to the mobile device based on the credentials.

16. The wireless camera of claim 15, wherein the instructions further cause the at least one processor to receive a second set of credentials from a second mobile device.

17. The wireless camera of claim 16, wherein the instructions further cause the at least one processor to withhold at least one of the image data captured by the image capture device and the at least the secondary image data stream from the second mobile device based on the second set of credentials.

18. The wireless camera of claim 15, wherein the instructions further cause the at least one processor to:
transmit the at least one secondary image data stream to the mobile device; and
withhold the image data captured by the image capture device from the mobile device.

19. The wireless camera of claim 15, wherein the credentials comprise a username and a password.

20. The wireless camera of claim 15, wherein the credentials comprise a device registration.
